(19) United States
(12) Patent Application Publication
(10) Pub. No.: US 2013/0136143 A1
(43) Pub. Date: May 30, 2013

(54) COMMUNICATION APPARATUS CAPABLE OF SELECTING USE BANDWIDTH, METHOD OF CONTROLLING COMMUNICATION APPARATUS, AND STORAGE MEDIUM

(71) Applicant: CANON KABUSHIKI KAISHA, Tokyo (JP)

(72) Inventors: Eiji Ohara, Kawasaki-shi (JP); Shigeru Koizumi, Tokyo (JP); Daisuke Suga, Kawasaki-shi (JP); Michio Fukushima, Yokohama-shi (JP)

(73) Assignee: CANON KABUSHIKI KAISHA, Tokyo (JP)

(21) Appl. No.: 13/678,757

(22) Filed: Nov. 16, 2012

(30) Foreign Application Priority Data
Nov. 30, 2011 (JP) 2011-261755

(51) Int. Cl. H04L 12/24

(52) U.S. Cl. CPC H04L 41/0896
USPC 370/468

(57) ABSTRACT

A communication apparatus which is capable of easily selecting a use bandwidth desired by a user when the user transmits data using via a network in which the use charge is different depending on the use bandwidth. A CPU acquires charge information indicative of a use charge in each of use bandwidths of the network. Further, the CPU determines a use bandwidth to be used for transmitting the data, according to the size of the data and the acquired charge information.

### BACKGROUND OF THE INVENTION

1. Field of the Invention

The present invention relates to a communication apparatus, a method of controlling the same, and a storage medium, and more particularly to a communication apparatus that transmits data using a network in which the use charge is different depending on the use bandwidth.

2. Description of the Related Art

In general, an NGN (Next Generation Network) is known in which a circuit-switched telephone network is replaced by an IP (Internet Protocol)-based network. Further, there has been widely spread a technique for providing services using the NGN.

The NGN has a bandwidth guaranteeing function and a security function provided on the network itself. This NGN is an IP network which integrally realizes a telephone service, a video communication service, a data communication service, and so forth, using SIP (Session Initiation Protocol). The NGN makes it possible to select between transmission speeds for which different communication charges (use charges) are set respectively.

In the present specification, a transmission capacity (transmittable bit rate) is sometimes referred to as a “use bandwidth”. In other words, the use bandwidth is sometimes expressed in bps (by bits per second).

On the other hand, there is known a communication terminal apparatus which is configured to perform T.38 data transmission using the same channel as a call connection channel established for SIP (see Japanese Patent Laid-Open Publication No. 2005-86724).

When a user transmits information, such as data, via a network, such as the NGN, in which the use charge is different depending on the use bandwidth, i.e. the transmission speed, it is not easy for the user to determine a use bandwidth to be selected for minimizing a transmission charge. That is, the user is not provided with criteria by which to select a desired use bandwidth, which makes it impossible for the user to determine how to select a use bandwidth.

### SUMMARY OF THE INVENTION

The present invention provides a communication apparatus which is capable of easily selecting a use bandwidth desired by a user when the user transmits data using via a network in which the use charge is different depending on the use bandwidth, a method of controlling the communication apparatus, and a storage medium.

In a first aspect of the present invention, there is provided a communication apparatus that transmits data using a network in which use charges are different depending on use bandwidths, comprising an acquisition unit configured to acquire charge information indicative of a use charge in each use bandwidth of the network, and a determination unit configured to determine a use bandwidth to be used for transmitting the data, according to a size of the data and the charge information acquired by the acquisition unit.

In a second aspect of the present invention, there is provided a method of controlling a communication apparatus that transmits data using a network in which use charges are different depending on use bandwidths, comprising acquiring charge information indicative of a use charge in each use bandwidth of the network, and determining a use bandwidth to be used for transmitting the data, according to a size of the data and the charge information acquired by the acquiring.

In a third aspect of the present invention, there is provided a non-transitory computer-readable storage medium storing a computer-executable control program for causing a computer to execute a method of controlling a communication apparatus that transmits data using a network in which use charges are different depending on use bandwidths, wherein the method comprises acquiring charge information indicative of a use charge in each use bandwidth of the network, and determining a use bandwidth to be used for transmitting the data, according to a size of the data and the charge information acquired by the acquiring.

According to the present invention, it is possible to easily select a use bandwidth desired by a user when the user transmits information, such as data, via a network, such as an NGN, in which the use charge is different depending on the use bandwidth.

Further features of the present invention will become apparent from the following description of exemplary embodiments with reference to the attached drawings.

### BRIEF DESCRIPTION OF THE DRAWINGS

FIG. 1 is a diagram of an example of a network system including an image communication apparatus according to an embodiment of the present invention.

FIG. 2 is a diagram of an example of a charge table defining the relationship between the use bandwidth (transmission speed) and charge information of an NGN appearing in FIG. 1.

FIG. 3 is a block diagram of the hardware configuration of one of the image communication apparatuses appearing in FIG. 1.

FIG. 4 is a flowchart of a transmission process performed by the image communication apparatus shown in FIG. 3.

FIGS. 5A and 5B are sequence diagrams useful in explaining processes carried out to establish a SIP session by the image communication apparatuses appearing in FIG. 3, in which FIG. 5A is a sequence diagram carried out to establish the SIP session by transmitting a SIP connection request message including an offer SDP, and FIG. 5B is a sequence diagram carried out to establish the SIP session by transmitting a SIP connection request message without an offer SDP.

FIG. 6 is a flowchart of a variation of the transmission process carried out by the image communication apparatus shown in FIG. 3.

FIG. 7 is a diagram of an example of a media stream description given in an SDP when the image communication apparatus shown in FIG. 3 declares facsimile communication based on ITU-T Recommendation T.38.

### DESCRIPTION OF THE EMBODIMENTS

The present invention will now be described in detail below with reference to the accompanying drawings showing an embodiment thereof. The following description will be given of an image communication apparatus, which is a type of communication apparatuses and is capable of transmitting multimedia data, by way of example.

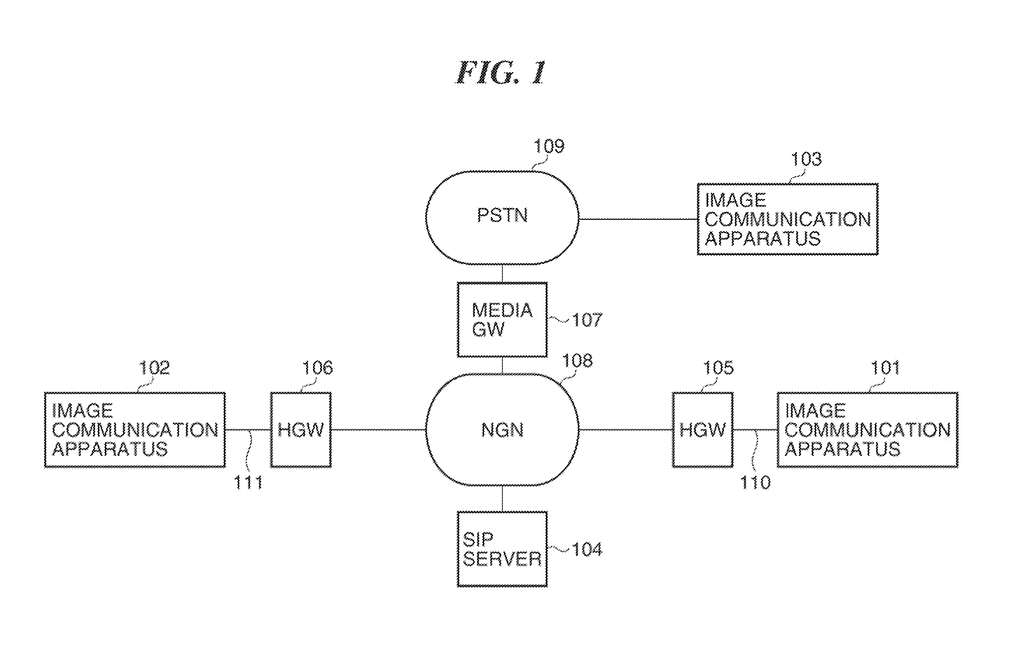

FIG. 1 is a diagram of an example of a network system including the image communication apparatus according to the embodiment of the present invention.

Referring to FIG. 1, connected to an NGN (Next Generation Network) 108 are a SIP (Session Initiation Protocol) server 104, home gateways (HGWs) 105 and 106, and a media gateway (media GW) 107. The media gateway 107 is connected to the image communication apparatus 103 via a PSTN (Public Switched Telephone Network) 109.

Further, the image communication apparatuses 101 and 102 are connected to the home gateways 105 and 106 via CSMA/CD (Carrier Sense Multiple Access with Collision Detection) interfaces 110 and 111, respectively.

The NGN 108 is provided with a plurality of use bandwidths (transmission speeds) for which different communication charges (use charges) are set, and to transmit data via the NGN 108, a user selects a desired use bandwidth. That is, the use charge of the NGN 108 is different depending on the bandwidth used for data transmission. In the following description, a transmission capacity or a transmission speed (transmittable bit rate) is sometimes referred to as a “use bandwidth”. In other words, the use bandwidth is sometimes expressed in bps (bits per second).

The SIP server 104 provides SIP (Session Initiation Protocol) services, such as conversion between a telephone number and an IP address, in order to perform a call connection process for IP telephone service or IP facsimile communication.

The home gateways 105 and 106 relay between the NGN 108 and the image communication apparatuses 101 and 102, respectively. The home gateways 105 and 106 are interfaces for performing facsimile communication according to a digital facsimile procedure specified in ITU-T Recommendation T.38, and facsimile communication according to a digital facsimile procedure specified in ITU-T Recommendation T.30 (T.30 facsimile communication by so-called treating-data-as-voice), respectively.

The media gateway 107 is provided by a telecommunications carrier or a network service provider so as to connect between the NGN 108 and the PSTN 109. The media gateway 107 performs e.g. digital-analog conversion between a voice signal and IP packets. Further, the media gateway 107 controls initiation of a call to a subscriber terminal (e.g. audio terminal: not shown) connected to the PSTN 109.

In the illustrated example, the image communication apparatus 103 is a G3 analog facsimile apparatus, and performs facsimile communication according to an analog facsimile procedure specified in ITU-T Recommendation T.30.

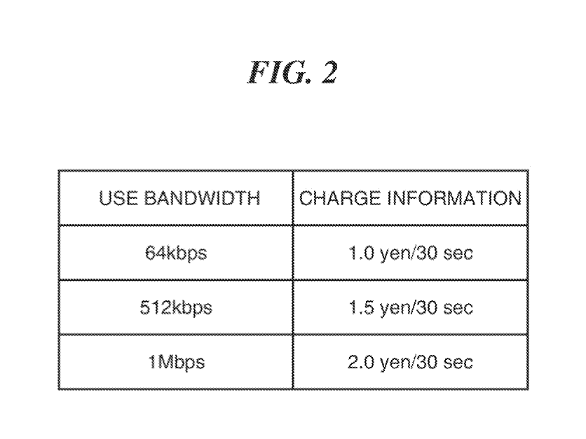

FIG. 2 is a diagram of an example of a charge table defining the relationship between the use bandwidth (transmission speed) and charge information of the NGN appearing in FIG. 1.

Referring to FIG. 2, the use bandwidth indicates a guaranteed bandwidth secured for transmission of data and the like performed using the NGN 108, i.e. a guaranteed transmission speed. Further, the charge information represents charging units applied to transmission performed using the NGN 108. In the illustrated example, communication charges (also referred to as “use charges”) are set in 30-seconds increments (i.e. charged per unit time of 30 seconds) in the respective use bandwidths.

As shown in FIG. 2, 64 kbps, 512 kbps, and 1 Mbps are set as the use bandwidths (i.e. the transmission speeds), and the user can select one of the use bandwidths. The charge information items of the use bandwidths of 64 kbps, 512 kbps, and 1 Mbps are 1.0 yen/30 seconds, 1.5 yen/30 seconds, and 2.0 yen/30 seconds, which means that the uses of bandwidths are billed on an as-used basis.

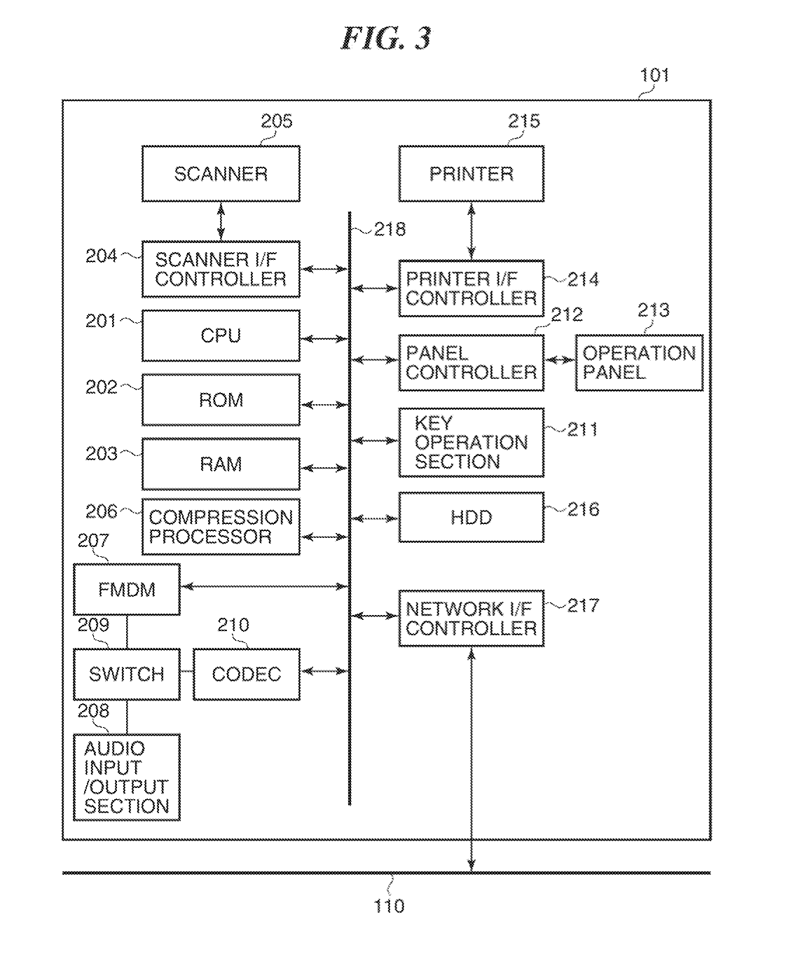

FIG. 3 is a block diagram showing an example of the hardware configuration of the image communication apparatus 101 shown in FIG. 1. Note that the image communication apparatus 102 has the same hardware configuration as that of the image communication apparatus 101.

Referring to FIG. 3, a CPU 201 controls the image communication apparatus 101 according to control programs stored in a ROM 202. The CPU 201 performs protocol processing using TCP/IP (Transmission Control Protocol/Internet Protocol) when performing control to assemble image data into TCP/IP frames.

A RAM 203 is used as a work memory when the CPU 201 executes the control program. Further, the RAM 203 is used as a buffer memory when the image communication apparatus 101 transmits and receives image data under the control of the CPU 201.

A scanner interface (I/F) controller 204 controls a scanner 205. An image obtained by scanning of an original by the scanner 205 is converted to digital data (image data) by the scanner interface controller 204. Then, this image data is transferred to the RAM 203 via a system bus 218 under the control of the CPU 201. The image data stored in the RAM 203 is transmitted or printed, as described hereinafter.

A compression processor 206 is an encoding and decoding processor using one of compression methods including MH, MR, MMR, and JBIG. When image data is to be transmitted, the compression processor 206 encodes the image data for data compression, whereas when encoded image data is received, the compression processor 206 decodes the received image data.

To perform facsimile transmission, a FAX modem (FMDM) 207 modulates encoded image data into an analog signal within a voice band can be transmitted using an analog line. When facsimile reception is performed, the FAX modem 207 demodulates a received analog signal into the encoded image data, and outputs the thus obtained encoded image data.

A voice input/output section (handset) 208 comprises a microphone (not shown) for inputting voice and a speaker (not shown) for outputting voice. A switch 209 is an analog switch for connecting one of the FAX modem 207 and the audio input/output section 208 to a CODEC (Coder/Decoder) 210.

In the example illustrated in FIG. 3, the CODEC 210 encodes or decodes a facsimile signal which is transmitted or received as a voice signal or a data signal which is treated as a voice signal (i.e. which is subjected to treating-data-as-voice), by a VoIP (Voice over Internet Protocol) method. Further, the CODEC 210 is assumed to support at least encoding and decoding of a T.38 Internet facsimile signal (particularly a tone signal), required for transmitting and receiving the signal.

A key operating section 211 comprises a dial and operation buttons (i.e. keys) operated during facsimile transmission and reception. The user gives key-input instructions using the key operating section 211. A panel controller 212 is connected to an operation panel 213 to control the same. The operation panel 213 displays various information items, and receives instructions input by the user.

A printer interface controller 214 controls a printer 215 under the control of the CPU 201. The printer 215 performs printing e.g. by an electrophotographic method or an inkjet method. The printer interface controller 214 converts image data to raster data for printing to output the same to the printer 215. The printer 215 performs printing based on the raster data for printing.

An HDD (Hard Disk Drive) 216 stores not only print data (image data) but also the charge table described with reference to FIG. 2, and so forth.

A network interface controller 217 is a LAN controller which performs transmission and reception of data and the like to and from the home gateway 105 via the CSMA/CD interface 110. When the CPU 201 transfers to-be-transmitted data to the network interface controller 217, the network interface controller 217 adds a MAC (Media Access Control) frame header, an FCS (Frame Check Sequence), and so forth, to the to-be-transmitted data, and transmits the resulting data to the CSMA/CD interface 110.

Note that the CPU 201, the ROM 202, the RAM 203, the scanner interface controller 204, the compression processor 206, the FAX modem 207, the CODEC 210, the key operating section 211, the panel controller 212, the printer interface controller 214, the HDD 216, and the network interface controller 217 are connected to each other by the system bus 218.

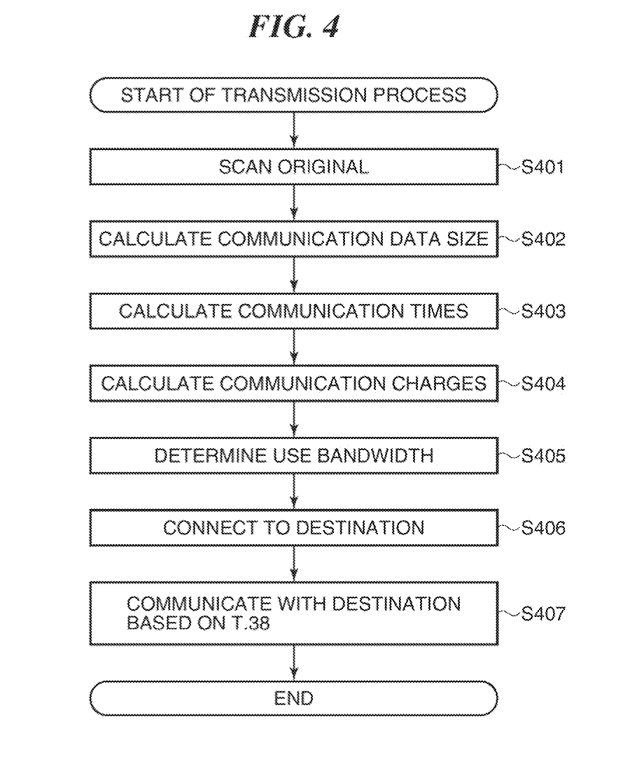

FIG. 4 is a flowchart of a transmission process performed by the image communication apparatus 101 shown in FIG. 3. Here, a description will be given of a case where image data obtained by scanning of an original by the scanner 205 is transmitted to a destination designated by the user.

Now, when the user completes setting of original reading and data transmission using the key operating section 211 or the operation panel 213, the CPU 102 starts the data transmission process.

When the data transmission process is started, the scanner interface controller 204 causes the scanner 205 to scan an original and obtains image data under the control of the CPU 102. This image data is transferred to the RAM 203 for temporary storage therein (step S401).

The image data stored in the RAM 203 is transferred to the compression processor 206 via the system bus 218. The compression processor 206 compresses the image data using e.g. JBIG, and then stores the compressed image data in the RAM 203. When scanning a plurality of originals, the originals are scanned one by one, and obtained image data is compressed by the compression processor 206 for storage in the RAM 203. Subsequently, the CPU 201 calculates a communication data size based on the amount of the compressed image data stored in the RAM 203 (step S402).

Next, the CPU 201 refers to the charge table stored in the HDD 216 (charge information storage unit), and divides the communication data size by each use bandwidth (transmission speed), to thereby calculate communication time for each use bandwidth (step S403). Note that the communication time may be determined not by dividing the communication data size by each use bandwidth at the start of the data transmission process, but by providing a table for managing communication time dependent on the communication data size and each use bandwidth in advance and referring to the table in the step 5403. The CPU 201 calculates a use charge on a use bandwidth basis according to the communication time, based on charge information obtained from the charge table (step S404).

The CPU 201 determines a use bandwidth that can be used at the lowest charge (which is most inexpensive), by comparing between the use charges of the respective use bandwidths (step S405). After that, the CPU 201 controls the network interface controller 217 to start a connection operation between the image communication apparatus 101 and a destination, using SIP (step S406). Then, the CPU 201 performs facsimile communication according to the digital facsimile procedure specified in ITU-T Recommendation T.38 (step S407), followed by terminating the data transmission process.

Note that the CPU 201 displays the determined use bandwidth as status information obtained during the data transmission process on the operation panel 213. Note that the CPU 201 may display the determined use bandwidth as communication history information on the operation panel 213, after termination of the data transmission process.

Next, a detailed description will be given of the processing in the steps S402 to S405 executed by the CPU 201.

As described hereinabove, in the step S402, the CPU 201 calculates the amount (total amount) of the compressed image data stored in the RAM 203 to thereby obtain the communication data size. Here, it is assumed that the communication data size is 2048 k bits.

In the charge table shown in FIG. 2, one of 64 kbps, 512 kbps, and 1 Mbps can be selected as a use bandwidth. In the case of the communication data size being 2048 k bits, communication time required for the use bandwidth of 64 kbps is 32 seconds, communication time required for the use bandwidth of 512 kbps is 4 seconds, and communication time required for the use bandwidth of 1 Mbps is 2 seconds.

Then, by referring to the charge information in the charge table, it is known that a communication charge for the use bandwidth of 64 kbps is 2.0 yen, a communication charge for the use bandwidth of 512 kbps is 1.5 yen, and a communication charge for the use bandwidth of 1 Mbps is 2.0 yen. From the above, the CPU 201 determines that the use bandwidth for which the communication charge is lowest is 512 kbps.

On the other hand, in the case of the communication data size being 1536 k bits, similarly, communication time required for the use bandwidth of 64 kbps is 24 seconds, communication time required for the use bandwidth of 512 kbps is 3 seconds, and communication time required for the use bandwidth of 1 Mbps is 1.5 seconds. Further, a communication charge for the use bandwidth of 64 kbps is 1.0 yen, a communication charge for the use bandwidth of 512 kbps is 1.5 yen, and a communication charge for the use bandwidth of 1 Mbps is 2.0 yen. From the above, the CPU 201 determines that the use bandwidth for which the communication charge is lowest is 64 kbps.

Note that in the charge table illustrated in FIG. 2, since the charge information gives information on charges per use, more specifically, charges in 30-seconds increments, and hence, the use bandwidth to be determined for use can be different depending on whether or not the communication is completed within 30 seconds.

Next, a detailed description will be given of SIP referred to in the steps S406 and S407.

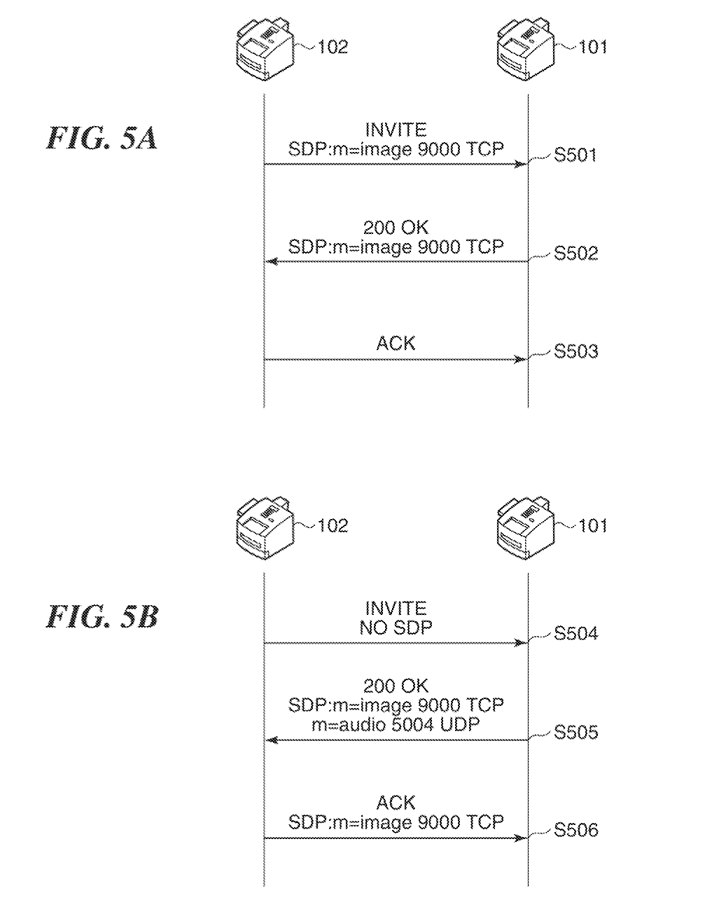

FIGS. 5A and 5B are sequence diagrams useful in explaining processes carried out to establish a SIP session by the image communication apparatuses 101 and 102 shown in FIG. 3, in which FIG. 5A is a sequence diagram carried out to establish the SIP session by transmitting a SIP connection request message including an offer SDP, and FIG. 5B is a sequence diagram carried out to establish the SIP session by transmitting a SIP connection request message without an offer SDP.

Here, a description will be given of a case where the image communication apparatus 102 appearing in FIG. 1 performs data communication with the image communication apparatus 101 as a destination (destination communication apparatus).

In the SIP session, first, an apparatus on a transmission side (transmission apparatus) transmits a SIP session establishment request (INVITE request) to an apparatus on a reception side (reception apparatus). Upon receipt of the INVITE request, the reception apparatus transmits a success response to the transmission apparatus. Upon receipt of the success response, the transmission apparatus transmits an acknowledge message to the reception apparatus. This procedure establishes the SIP session.

At this time, as to media used in the SIP session, the transmission apparatus and the reception apparatus exchange SDP (Session Description Protocol) messages describing e.g. a port number for receiving desired media with each other (SDP negotiation), and determine the parameters of the session.

Referring to FIG. 5A, the image communication apparatus 102 transmits a SIP connection request message (INVITE message) to the image communication apparatus 101 as the destination (step S501). The SIP connection request message includes an SDP describing information on media desired to be used in the SIP session and a reception port number.

In the illustrated example, the SDP describes that m=image 9000 TCP, and hence a request is made to establish a SIP session for performing data communication in which the media type is “image” and a TCP port number of 9000 is used.

Upon receipt of the SIP connection request message, the image communication apparatus 101 checks the offer SDP included in the SIP connection request message. Then, if the SDP describes a media type compatible with the image communication apparatus 101, the image communication apparatus 101 transmits a 200 OK message as a response message to the image communication apparatus 102 (step S502).

The 200 OK message includes an SDP that describes a media type to be accepted by the image communication apparatus 101 and a reception port number. In the illustrated example, the SDP describes m=image 9000 TCP. This means that the image communication apparatus 101 agrees to establishing the SIP session for performing data communication using media the type of which is “image” and the TCP port number 9000 as a reception port.

Upon receipt of the 200 OK message, the image communication apparatus 102 transmits an ACK (Acknowledge) message indicating that it has received the 200 OK message (step S503). This establishes the SIP session for performing data communication in which the media type is agreed between the image communication apparatuses 102 and 101.

Referring to FIG. 5B, the image communication apparatus 102 transmits a SIP connection request message (INVITE message) to the image communication apparatus 101 (step S504). This SIP connection request message does not include the above-described offer SDP.

Upon receipt of the SIP connection request message, the image communication apparatus 101 checks whether or not the SIP connection request message includes an offer SDP. Here, since no offer SDP is included in the SIP connection request message, the image communication apparatus 101 transmits a 200 OK message that includes an offer SDP describing a media type compatible with the image communication apparatus 101 and a reception port number, to the image communication apparatus 102 (step S505).

In the example illustrated in FIG. 5B, the SDP describes m=image 9000 TCP and m=audio 5004 UDP (User Datagram Protocol). This means that the image communication apparatus 101 has made a request to establish a SIP session for performing one or both of the data communication in which the media type is “image” and the TCP port number of 9000 is used and data communication in which the media type is “audio” and a TCP port number of 5004 is used.

Upon receipt of the 200 OK message, the image communication apparatus 102 checks the offer SDP included in the 200 OK message. If the SDP describes a media type compatible with the image communication apparatus 102, the image communication apparatus 102 transmits an ACK message indicating that it has received the 200 OK message (step S506).

The ACK message includes an SDP that describes a media type to be accepted by the image communication apparatus 102 and a reception port number. In the illustrated example, the SDP describes m=image 9000 TCP. This means that the image communication apparatus 102 agrees to establishing the SIP session for performing data communication using media the type of which is “image” and the TCP port number 9000 as a reception port.

This establishes the SIP session for performing data communication using media the type of which is agreed between the image communication apparatuses 102 and 101.

By the way, in a case where the use bandwidth determined by the CPU 201 is 64 kbps or 512 kbps, the SDP may be configured to describe b=AS:64 or b=AS:512.

As described hereinabove, the SIP message stores SDP information including a media stream description of parameters, such as m-line, a-line, referred to hereinafter, and b-line”, which describe a type of media (audio, video, or data), a communication method (two-way communication or one-way communication), and a bandwidth, respectively.

According to the SIP, a call control process is performed which establishes a SIP session for performing data communication using media the type of which is agreed between the image communication apparatuses 102 and 101, by way of the SIP server 104 appearing in FIG. 1. At this time, the SIP server 104 reads SDP information from a SIP message, and executes processing for determining the use bandwidth of the NGN 108 in parallel with the call control process.

Although in the above described example, in determining a use bandwidth, the CPU 201 selects a use bandwidth for which the communication charge is lowest, at this time, it is desirable that the image communication apparatus on the transmission side is equipped with a transmission capability not lower than the determined use bandwidth, i.e. transmission speed. When this condition is satisfied, it is possible to perform image communication which makes full use of the use bandwidth of the NGN determined by the CPU 201.

Therefore, to make full use of the transmission capability of the image communication apparatus on the transmission side, the transmission capability of the image communication apparatus may be stored in advance in the HDD 216, and the CPU 201 may determine a use bandwidth by excluding use bandwidths exceeding the transmission capability from consideration for selection.

Further, the reception capability of the image communication apparatus on the reception side may be grasped in advance by the image communication apparatus on the transmission side, and be stored in the HDD 216 in the same manner. Further, when determining a use bandwidth, the CPU 201 may determine a use bandwidth by excluding use bandwidths exceeding the transmission capability of the image communication apparatus on the reception side from consideration for selection.

Furthermore, although in the above described example, the CPU 201 determines a use bandwidth for which the communication charge is lowest, a use bandwidth to be determined may be limited according to a user's usage environment. For example, depending on the type and number of sheets of originals, when there is a use bandwidth which is rarely selected, the CPU 201 may exclude such a use bandwidth from consideration for selection. Further, the image transmission apparatus may be configured such that when the user designates a higher priority to communication time than to a communication charge, the CPU 201 performs selection of a use bandwidth according to the designation.

Specifically, when black-and-white image data is to be transmitted, the use bandwidth of 1 Mbps is rarely selected, and this use bandwidth is excluded from consideration for selection. Further, when color image data is to be transmitted, if the CPU 201 is instructed to give a higher priority to communication time, the CPU 201 may exclude the use bandwidth of 64 kbps from consideration for selection.

Note that although in the charge table shown in FIG. 2, three types of use bandwidths are registered, this not limitative, but a plurality of use bandwidths, which may include two or more than three use bandwidths, may be registered.

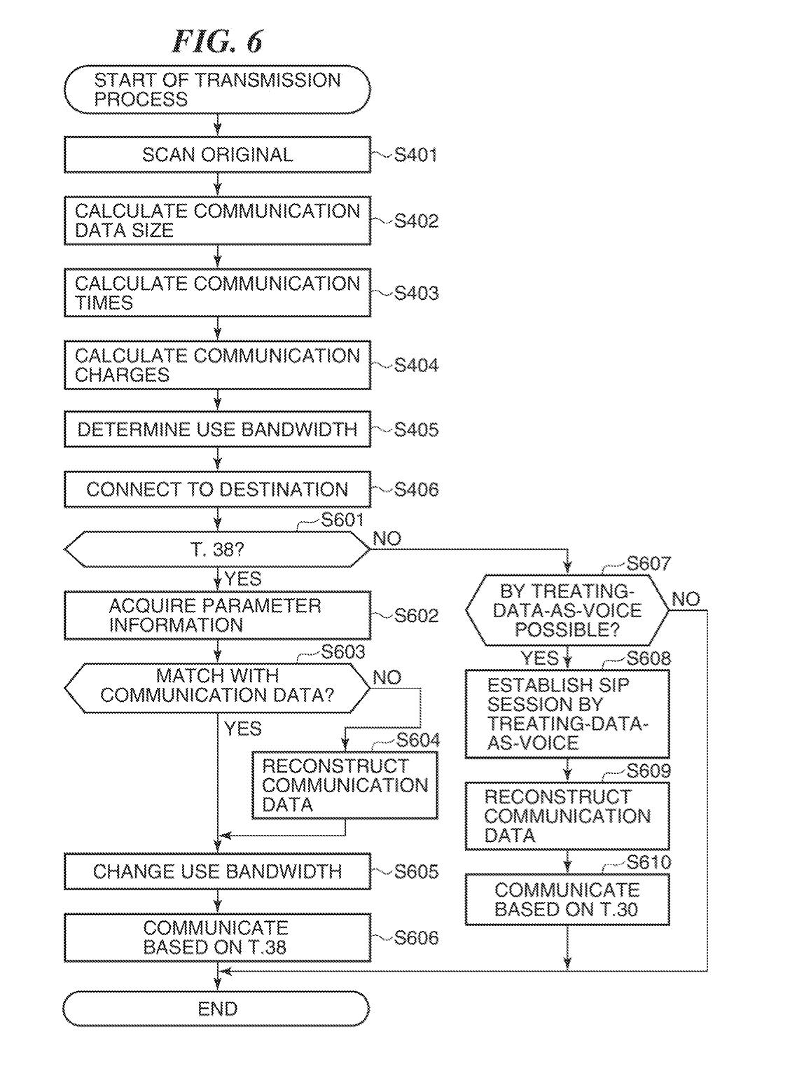

FIG. 6 is a flowchart of a variation of the transmission process carried out by the image communication apparatus 101 shown in FIG. 3. In the flowchart shown in FIG. 6, the same steps as appearing in FIG. 4 are denoted by the same reference numerals and description thereof is omitted.

In the S406, the establishment of the SIP session (connection to a recipient) is performed as described with reference to FIGS. 5A and 5B. Then, the CPU 201 determines whether or not the data communication is facsimile communication based on ITU-T Recommendation T.38 (step S601). Here, when the SDP describes m=image 9000 TCP, the data communication specifies facsimile communication based on ITU-T Recommendation T.38.

If it is determined that the data communication is facsimile communication (YES to the step S601), the CPU 201 acquires more detailed parameter information (also referred to as “transmission parameter information”) formed by expanding a media stream description in the SDP (step S602).

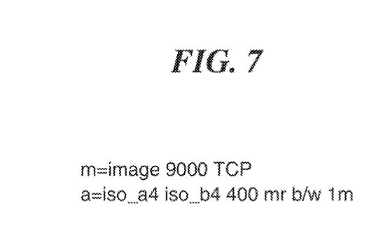

FIG. 7 is a diagram of an example of the media stream description given in the SDP when the image communication apparatus 101 shown in FIG. 3 declares facsimile communication based on ITU-T Recommendation T.38.

As described hereinabove, when the SDP describes m=image 9000 TCP, the establishment of the SIP session is declared which performs data communication using media the type of which is “image” and the TCP port number 9000 as a reception port.

Further, here, image communication control parameters used for image communication are declared using the following syntax: “a=iso_a4 iso_b4 400 mr b/w 1 m”.

In the illustrated example, descriptions “iso_a4” and “iso_b4” in this example mean that A4 and B4 recording sheets are applicable. Although this syntax can also be used to declare original sizes of transmitted images, in this case, only a single type is normally specified.

Further, “400” means that the resolution of the transmitted or received images is 400 dpi, and “mr” means that an applicable image compression method is MR (Modified READ). Furthermore, “b/w” indicates a black-and-white image. “1 m” means that a transmission or reception speed is 1 Mbps.

Thus, the SIP session is established by the agreement between the image communication apparatus on the transmission side and the image communication apparatus on the reception side, and further the image communication control parameters are acquired. The CPU 201 determines whether or not the compressed image data stored in the RAM 203 matches the image communication control parameters (step S603).

If it is determined that the compressed image data does not match the image communication control parameters (NO to the step S603), the CPU 201 reconstructs the compressed image data (step S604). Here, the reconstruction of the compressed image data is image processing performed on the compressed image data so as to convert the same into data matching the image communication control parameters. In short, the CPU 201 performs image processing on the compressed image data according to the image communication control parameters.

For example, when the image communication control parameters specify a black-and-white image, if the compressed image data is color image data, the CPU 201 converts the compressed image data to black-and-white image data. If a resolution specified by the image communication control parameters is different from the resolution of the compressed image data, the CPU 201 changes the resolution of the compressed image data. Further, if a compression method specified by the image communication control parameters is different from a compression method applied to the compressed image data, the CPU 201 changes the compression method used for compressing image data into the compressed image data.

Then, in a case where the reception capability of the image communication apparatus on the reception side (i.e. receiving transfer rate) is lower than the use bandwidth determined as described above, the CPU 201 changes the use bandwidth to a use bandwidth compatible with the reception capability (step S605). More specifically, even if the use bandwidth determined as described above is used, it is impossible to perform the facsimile communication at the transmission speed of the use bandwidth, and hence the CPU 201 changes the use bandwidth to a use bandwidth compatible with the reception capability. After that, the CPU 201 causes the network interface controller 217 to perform facsimile communication based on ITU-T Recommendation T.38 (step S606), followed by terminating the transmission process.

Note that when the CPU 201 reconstructs the compressed image data, the transmission capability of the image communication apparatus on the transmission side sometimes becomes lower than the use bandwidth determined as described above. In this case as well, the CPU 201 changes the use bandwidth to a use bandwidth compatible with the transmission capability. Further, if it is determined that the compressed image data matches the image communication control parameters (YES to the step S603), the CPU 201 directly proceeds to the step S605 to change the use bandwidth on an as-needed basis.

If it is determined that the data communication is not facsimile communication (NO to the step S601), that is, if it is impossible to establish a SIP session for data communication in which the media type is “image”, the CPU 201 determines whether or not it is possible to establish a SIP session for data communication in which the media type is “audio” (step S607).

For example, when the SDP explained in the step S505 in FIG. 5B describes m=audio, 5004 UDP, “audio” means facsimile communication by treating-data-as-voice, specified in ITU-T Recommendation T.30. Therefore, if it is determined that facsimile communication by treating-data-as-voice, specified in ITU-T Recommendation T.30, can be performed (YES to the step S607), the CPU 201 establishes a SIP session for data communication in which the data type is “audio”. That is, the CPU 201 establishes the SIP session for facsimile communication by treating-data-as-voice (step S608).

Next, when facsimile communication is performed by treating-data-as-voice, the CPU 201 reconstructs the compressed image data stored in the RAM 203 (step S609). Here, the CPU 201 decodes the compressed image data into decompressed image data by the compression processor 206, and then converts the decompressed image data to treated-as-voice data by the CODEC 210. That is, the CPU 201 performs encoding processing by the VoIP method.

After reconstruction of the compressed image data, the CPU 201 causes the network interface controller 217 to perform facsimile communication by treating-data-as-voice, specified in ITU-T Recommendation T.30 (step S610), followed by terminating the transmission process.

If it is determined that facsimile communication by treating-data-as-voice, specified in ITU-T Recommendation T.30 cannot be performed (NO to the step S607), the CPU 201 terminates the transmission process.

As described heretofore, in the embodiment of the present invention, when data transmission is performed via a network, such as the NGN, in which the use charge is different depending on the use bandwidth, it is possible to easily select a desired use bandwidth by taking into account the use charge and communication time. This makes it possible to optimize communication charges while taking communication time into account.

As is apparent from the above description, in the example illustrated in FIG. 3, the CPU 201 functions as an acquisition unit and a determination unit. Further, the CPU 201 and the network interface controller 217 function as a session establishing unit, and the CPU 201 also functions as a parameter acquiring unit and a changing unit.

Although in the above-described embodiment, the communication apparatus is described by taking the image communication apparatus as an example, the present invention can also be applied to any other apparatus, insofar as the apparatus performs transmission of data, such as information, using a network, such as the NGN in which the use charge is different depending on the use bandwidth.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

For example, the functions of the above-described embodiment can be accomplished by causing the communication apparatus to execute the functions as a control method. Further, the functions of the above-described embodiment may be accomplished by causing a computer incorporated in the communication apparatus to execute programs implementing the functions, as control programs. Note that each control program is stored e.g. in a computer-readable storage medium.

In this case, each of the control method and the control program includes at least acquiring and determining.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

This application claims priority from Japanese Patent Application No. 2011-261755 filed Nov. 30, 2011, which is hereby incorporated by reference herein in its entirety.

What is claimed is:

1. A communication apparatus that transmits data using a network in which use charges are different depending on use bandwidths, comprising:
an acquisition unit configured to acquire charge information indicative of a use charge in each use bandwidth of the network; and
a determination unit configured to determine a use bandwidth to be used for transmitting the data, according to a size of the data and the charge information acquired by said acquisition unit.

2. The communication apparatus according to claim 1, wherein said determination unit calculates communication time taken to transmit the data in each use bandwidth of the network, based on the size of the data, and determines the use bandwidth to be used for transmitting the data based on the calculated communication time and the charge information.

3. The communication apparatus according to claim 2, wherein said determination unit calculates use charges required to transmit the data in the use bandwidths, respectively, based on the communication time and the charge information, and determines the use bandwidth to be used for transmitting the data based on the calculated use charges.

4. The communication apparatus according to claim 3, wherein said determination unit determines a use bandwidth for which the use charge is lowest, as the use bandwidth to be used for transmitting the data.

5. The communication apparatus according to claim 1, further comprising:
a session establishing unit configured to establish a session with a destination communication apparatus after the use bandwidth to be used for transmitting the data is determined by said determination unit;
a parameter acquiring unit configured to acquire transmission parameter information concerning transmission of the data from the destination communication apparatus, through establishment of the session; and
a construction changing unit configured to change construction of the data based on the transmission parameter information, and
wherein when the construction of the data is changed by said construction changing unit, said determination unit determines whether or not to change the determined use bandwidth according to the change of the construction of the data.

6. The communication apparatus according to claim 5, wherein said session establishing unit establishes the session using SIP.

7. The communication apparatus according to claim 1, wherein the network is a next generation network (NGN).

8. A method of controlling a communication apparatus that transmits data using a network in which use charges are different depending on use bandwidths, comprising:
acquiring charge information indicative of a use charge in each use bandwidth of the network; and
determining a use bandwidth to be used for transmitting the data, according to a size of the data and the charge information acquired by said acquiring.

9. A non-transitory computer-readable storage medium storing a computer-executable control program for causing a computer to execute a method of controlling a communication apparatus that transmits data using a network in which use charges are different depending on use bandwidths,
wherein the method comprises:
acquiring charge information indicative of a use charge in each use bandwidth of the network; and
determining a use bandwidth to be used for transmitting the data, according to a size of the data and the charge information acquired by said acquiring.
